(19) United States
(12) Patent Application Publication
(10) Pub. No.: US 2016/0197698 A1
(43) Pub. Date: Jul. 7, 2016

(54) ALL-OPTICAL ORTHOGONAL FREQUENCY DIVISION MULTIPLEXING (OFDM) DEMULTIPLEXER

(71) Applicant: DANMARKS TEKNISKE UNIVERSITET, Lyngby (DK)

(72) Inventors: Leif Katsuo Oxenløwe, Hillerød (DK); Evarist Palushani, Copenhagen S (DK); Hans Christian Hansen Mulvad, Copenhagen NV (DK); Michael Galili, Roskilde (DK)

(21) Appl. No.: 14/916,770

(22) PCT Filed: Sep. 2, 2014
(86) PCT No.: PCT/DK2014/050268

§ 371 Date: Mar. 4, 2016

(30) Foreign Application Priority Data
Sep. 6, 2013 (EP) 13183445.9

(51) Int. Cl. H04J 14/02; H04L 5/00; H04B 10/67; H04B 10/548

(52) U.S. Cl. CPC H04J 14/0221; H04B 10/548; H04L 5/0007; H04B 10/675

(57) ABSTRACT

The invention relates to an all-optical demultiplexer for an optical orthogonal frequency division multiplexing (OFDM) signal having a centre wavelength. The OFDM signal comprises a plurality of subcarriers, each subcarrier having a symbol rate. The demultiplexer is adapted for spectrally magnifying the OFDM signal and comprises a first time lens, a second time lens, and a dispersive element. The dispersive element is arranged in a signal path between the first time lens and the second time lens to form a time lens telescope. The invention further relates to a method of demultiplexing OFDM signals.

### FIELD OF THE INVENTION

The present invention relates to an all-optical orthogonal frequency division multiplexing (OFDM) demultiplexer. The invention further relates to a method of all-optical demultiplexing of OFDM signals.

### BACKGROUND OF THE INVENTION

The Internet traffic is constantly growing, and it is soon expected to reach the capacity of the currently installed communication systems. Consequently, there is a strong focus in research laboratories on how to better exploit the available bandwidth of the installed optical fiber-based links. In particular, spectrally efficient multiplexing techniques where subcarriers at different wavelengths are placed at closely spaced frequencies have received significant attention. In the past decades, dense wavelength division multiplexing (DWDM) has enabled significant increases in capacity, but this is no longer sufficient.

Today, one of the most studied multiplexing techniques is orthogonal frequency division multiplexing (OFDM), which enables even closer frequency spacing than DWDM, approaching—or even equal to—the subcarrier symbol rate, which is the theoretical limit (cf references below). The OFDM subcarriers have a square-like time-domain waveform, and correspondingly a sinc-like profile in the frequency domain with nulls at evenly spaced frequencies, with spacing equal to the symbol rate. The subcarriers are placed with the same spacing, thus overlapping with a frequency null-point of all other subcarriers. This so-called “orthogonality” condition implies that the subcarrier channels can be demultiplexed (separated) at the receiver ideally without inter carrier cross-talk (ICI), even though their spectra are strongly overlapping.

Typically, such an operation is carried out in the electrical domain using digital signal processing (DSP), after detection and analog-to-digital conversion (ADC) of the OFDM signal. In this case, however, the capacity of the OFDM signal is limited by the speed of electronics to about 100 Gbit/s.

On the other hand, in “all-optical OFDM” (AO-OFDM) the demultiplexing is performed optically, enabling significantly larger capacity for the OFDM signal. The AO-OFDM approach is also attractive since digital/analog conversion and DSP are avoided both the demultiplexing (at the receiver) and for the multiplexing (at the transmitter). For the demultiplexing, it is important to note that the individual OFDM subcarriers cannot simply be extracted by optical bandpass filtering (as in traditional WDM systems), since this would imply a large penalty due to cross-talk (ICI) from the spectrally overlapping neighbouring subcarriers.

To solve this issue, optical subcarrier demultiplexing has been demonstrated by so-called optical discrete Fourier transformation (DFT) based on various structures of optical splitters, delays, phase-shifters and time-gates. However, for an OFDM signal with N channels, N time-gates are required. Thus, this approach does not scale well to large numbers of channels. Another problem of this system is the power consumption, which will scale linearly with the number of channels.

Hence, an improved OFDM demultiplexer would be advantageous, and in particular a demultiplexer which would scale efficiently in both power and system cost to a large number of channels would be advantageous.

### OBJECT OF THE INVENTION

It is a further object of the present invention to provide an alternative to the prior art.

In particular, it may be seen as an object of the present invention to provide a demultiplexer that solves the above mentioned problems of the prior art of scaling efficiently to a large number of OFDM channels.

### SUMMARY OF THE INVENTION

Thus, the above described object and several other objects are intended to be obtained in a first aspect of the invention by providing a method of all-optical demultiplexing of an optical orthogonal frequency division multiplexing (OFDM) signal. The method comprises providing an input OFDM signal comprising a plurality of subcarriers, which subcarriers corresponding to data channels. The method further comprises ensuring that bit sequences of the individual data channels are substantially synchronized within the input OFDM signal. Finally, the method comprises all-optical spectrally magnifying the input OFDM signal by use of an optical time lens and a dispersive element. In this way, simple bandpass filtering, as known from wavelength division multiplexing (WDM) systems may be used to extract the individual OFDM subcarriers, while excessive inter-carrier interference (ICI) is suppressed. Furthermore, the need for an active optical gate, as required by the optical discrete Fourier transformation (DFT)-method, is avoided. Thus, only two active devices, in the form of phase-modulators, are needed—regardless of the number of data channels. In addition, since demultiplexing according to the invention is performed all-optically, the method is applicable to high bit rates. The inventive method of demultiplexing is phase-preserving, and is thus transparent to modulation format. As such, subcarriers being modulated by both simple modulation formats, such as on-off keying (OOK) and more advanced formats such as differential phase-shift keying (DPSK) or quadrature amplitude modulation (QAM) may be demultiplexed using this method and the demultiplexer according to the invention. Furthermore, the method may be used to demultiplex OFDM signals at any wavelength range and at any bit-rate, provided that a suitable optical time lens may be implemented for the given wavelength range or bit-rate, respectively.

In one embodiment of the method according to the invention, the spectral magnification comprises applying a first phase modulation to the input OFDM signal in a first time lens to obtain a first chirped signal, the first phase modulation being substantially quadratic as a function of time substantially throughout a bit time slot of a subcarrier and having a chirp rate C₁. The magnification further comprises applying chromatic dispersion via the dispersive element to the first chirped signal to obtain a dispersed signal, the chromatic dispersion having a dispersion parameter D. Subsequently, the magnification comprises applying a second phase modulation to the dispersed signal in a second time lens to obtain a spectrally magnified signal, the second phase modulation being substantially quadratic as a function of time substantially throughout the bit time slot and having a chirp rate C₂. The chirp rates and dispersion parameter are chosen to fulfil

$$D = \frac{1}{{C}_{1}} + \frac{1}{{C}_{2}} .$$

The spectral magnification is given by

$$M = - \frac{{C}_{2}}{{C}_{1}} .$$

In one embodiment of the inventive method, the first and second time lenses are implemented as separate optical elements.

In another embodiment of the inventive method, the first and second time lenses are implemented as separate passes of the signal through a single nonlinear element, which is operable to achieve both the required chirp rates depending on a propagation direction of the signal.

In one embodiment of the method according to the invention, the chirp rates are selected to give a spectral magnification in the range 2-100, such as 2.5-10, or even 3-8.

In one embodiment of the method according to the invention, the method further comprises detecting a data content of a subcarrier with a receiver. The receiver may be a DWDM receiver, adapted to simultaneously detect several channels.

In an alternative embodiment, the receiver may be adapted for detecting just one channel, such as a photodiode measuring the output of the bandpass filter.

Furthermore, the above described object and several other objects are intended to be obtained in a second aspect of the invention by providing an all-optical demultiplexer for an optical orthogonal frequency division multiplexing (OFDM) signal. The OFDM signal has a centre wavelength and comprises a plurality of subcarriers, each subcarrier having a symbol rate. The demultiplexer is adapted for spectrally magnifying the OFDM signal and comprises a first time lens, a second time lens, and a dispersive element. The first time lens is operable to have a substantially quadratic phase modulation as a function of time over a time period substantially corresponding to the symbol rate, the phase modulation having a chirp rate C₁. Likewise, the second time lens, is operable to have a substantially quadratic phase modulation as a function of time over a time period substantially corresponding to the symbol rate, the phase modulation having a chirp rate C₂. The dispersive element is arranged in a signal path between the first time lens and the second time lens, the dispersive element having a dispersion parameter, D, at the centre wavelength. The chirp rates C₁, C₂ and the dispersion parameter D may be chosen during operation to substantially fulfil D=1/C₁+1/C₂. In this way, the incoming OFDM signal may be efficiently demultiplexed into a wavelength division multiplexing (WDM) signal, which may be received by conventional means, such as a WDM receiver. Thus, bandpass filtering may be employed to extract a single subcarrier from the spectrally magnified OFDM signal.

In one embodiment, the chirp rates and dispersion parameter are chosen to ensure that the incoming OFDM signal is demultiplexed into a dense-WDM (DWDM) signal, wherein individual DWDM subcarriers spectrally coincide with the ITU-grid.

In one embodiment of the demultiplexer according to the invention, the demultiplexer further comprises a synchronizer for aligning bit slots of the individual subcarriers to substantially coincide.

In one embodiment of the demultiplexer according to the invention, the synchronizer is or comprises a chromatic dispersion compensator, such as a dispersion compensating fibre (DCF).

In one embodiment of the demultiplexer according to the invention, the first time lens and the second time lens comprise a common nonlinear element, wherein the common nonlinear element is adapted to function as the first time lens for a first signal propagating along a first propagation direction and is adapted to function as the second time lens for a second signal propagating along a second propagation direction. In this way, only one nonlinear element is needed, which potentially reduces component costs and may improve compactness. The skilled person will realize the wide available choice of nonlinear elements suitable for use in the demultiplexer of the invention, either as the common nonlinear element, or as elements of the first and/or second time lens.

In one embodiment the first signal and the second signal are counter-propagating.

In an alternative embodiment, the common nonlinear element is adapted to function as the first time lens for signals propagating in a first polarization state and is adapted to function as the second time lens for signals propagating in a second polarization state.

In one embodiment of the demultiplexer according to the invention, the first and/or second time lens is configured for phase modulation by a χ⁽³⁾-effect. In this way, the use of a wide range of commercially available nonlinear elements is enabled. Examples of such nonlinear elements are a highly nonlinear fibre (HNLF), including types of photonic crystal fibres, or silicon waveguides, including silicon nanowires.

In one embodiment of the demultiplexer according to the invention, the demultiplexer comprises an optical pump for generating chirped pump pulses, and wherein the first and/or second time lens is configured for phase modulation by four-wave mixing (FWM) between the chirped pump pulses and the signal. Using FWM, it is possible to achieve a large chirp rate. Consequently, a large spectral magnification is achievable.

In one embodiment of the demultiplexer according to the invention, the demultiplexer comprises an optical pump for generating parabolic intensity profile pump pulses, and wherein the first and/or second time lens is configured for phase modulation by cross-phase modulation (XPM) between the parabolic intensity profile pump pulses and the signal. XPM may be performed in-band, i.e. such that wavelengths of the modulated signals are not changed by the modulation. In this way, a more spectrally efficient demultiplexer may be achieved.

In one embodiment of the demultiplexer according to the invention, the first and/or second time lens is configured for phase modulation by a χ⁽²⁾-effect. This enables the use of a lower pump power to achieve a given phase modulation resulting in an improved energy efficiency.

In one embodiment, the first and/or second time lens comprises a nonlinear crystal, such as a periodically-poled Lithium Niobate (PPLN) crystal.

In one embodiment of the demultiplexer according to the invention, the first and/or second time lens is or comprises an electro-optic phase modulator. In this way, a particularly simple system configuration may be used, which does not require the use of an optical pulse source. The electro-optic phase modulator is driven by an electrical driving signal.

In one embodiment of the demultiplexer according to the invention, the dispersive element is or comprises an optical fibre. In this way, a readily available dispersive element may be used. Furthermore, optical fibres are practical to use and many tools are available for handling. In addition, optical fibres commonly have low optical loss.

In one embodiment, the optical fibre is a standard single mode fibre (SSMF). In this way, a particularly low cost dispersive element is achieved.

In one embodiment, the optical fibre is a dispersion-compensating fibre (DCF). In this way, the length of fibre required to achieve a desired dispersion may be reduced. This potentially improves the optical stability of the demultiplexer, e.g. due to thermal variations.

In an alternative embodiment, the dispersive element is or comprises a grating. In this way, a particularly compact dispersive element may be realized.

In some embodiments, the grating is adapted to have a tunable chromatic dispersion.

In one embodiment of the demultiplexer according to the invention, the demultiplexer is operable to perform the abovementioned method of demultiplexing.

The first and second aspects of the present invention may each be combined with any of the other aspects. These and other aspects of the invention will be apparent from and elucidated with reference to the embodiments described hereinafter.

### BRIEF DESCRIPTION OF THE FIGURES

The OFDM demultiplexer according to the invention will now be described in more detail with regard to the accompanying figures. The figures show one way of implementing the present invention and is not to be construed as being limiting to other possible embodiments falling within the scope of the attached claim set.

FIG. 1 shows a schematic overview of an OFDM communication system using the demultiplexer according to the invention,

FIG. 2 illustrates the demultiplexer and method of demultiplexing according to the invention,

FIG. 3 shows simulation results of demultiplexing OFDM signals,

FIG. 4 illustrates an embodiment of the demultiplexer,

FIG. 5 shows an experimental setup of example 1 for proof-of-principle demultiplexing according to an embodiment of the invention,

FIGS. 6-8 shows experimental results of example 1.

### DETAILED DESCRIPTION OF AN EMBODIMENT

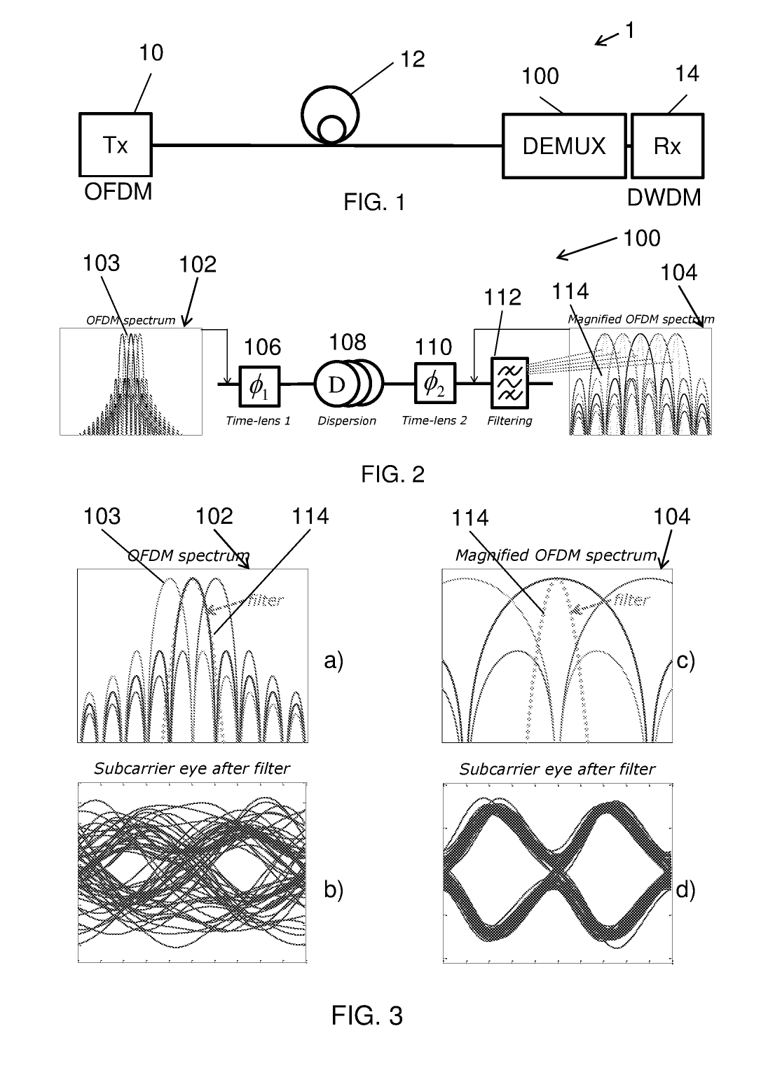

FIG. 1 schematically illustrates an optical OFDM communication system 1 using the demultiplexer according to the invention 100. The system comprises an OFDM transmitter 10, which generates and data modulates a number of OFDM-subcarriers e.g. in response to incoming data streams (not shown). The subcarriers together form an OFDM signal. The OFDM signal is transmitted over a transmission span of optical fibre 12. At the receiver end, the OFDM signal is demultiplexed in the demultiplexer 100 into a DWDM signal, which may be detected by conventional means, such as a DWDM receiver 14.

FIG. 2 illustrates the demultiplexer 100 and method of demultiplexing according to aspects of the invention. The spectrum 102 of an incoming OFDM signal is shown, here illustrated with 5 channels 103 although any number of channels may be used. It is clearly seen that the sinc-like profiles of the individual spectra are strongly overlapping the neighbouring channels in the frequency domain. Not illustrated is that first it is ensured that the bit slots of the individual channels are synchronized. This may e.g. be achieved by compensating the chromatic dispersion experienced by the signals during propagation from the transmitter. Alternatively, an active synchronizator may be employed to synchronize an arbitrarily unaligned OFDM signal. The incoming OFDM signal 102 is spectrally magnified by phase modulation with a quadratic phase modulation in the first time lens 106, dispersion in the dispersive element 108, and phase modulation again with another quadratic phase modulation in the second time lens 110. The magnified OFDM spectrum 104 is illustrated at the far right side of the figure. Also illustrated in the magnified spectrum 104 is Gaussian-like profile 114 of the optical bandpass filter 112 which may now be used to extract the individual OFDM subcarriers from the spectrally magnified signal.

FIG. 3 shows simulation results for demultiplexing of an OFDM signal. FIG. 3a shows the spectrum 102 of the three subcarriers/channels 103 studied here. It is clearly seen that the first nulls of e.g. the centre-most subcarrier on each side are made to coincide with the peaks of the neighbouring subcarriers. In other words, the orthogonality condition of the OFDM signal is fulfilled, since the subcarrier spacing is made to coincide with the nulls of the individual subcarriers, which is again corresponding to the symbol rate. Also illustrated overlapping with the central peak of the centre-most subcarrier is the minimum filter bandwidth 114 which may be used to spectrally filter the signals, approximately equal to the symbol rate and thus the subcarrier spacing. If a smaller filter bandwidth is used, the pulses of the subcarrier would broaden so as to significantly overlap, thus resulting in excessive cross-talk between successive symbols in the same subcarrier channel. The result of simply bandpass filtering for a single subcarrier in the OFDM using this filter is seen in the eye diagram, FIG. 3b. Here, significant inter-carrier interference (ICI) is seen to severely distort the signal. In contrast, if the spectrum 104 is magnified ×4, as illustrated in FIG. 3c, bandpass filtering with the same filter 114 is seen to result in the clear eye-diagram of FIG. 3d.

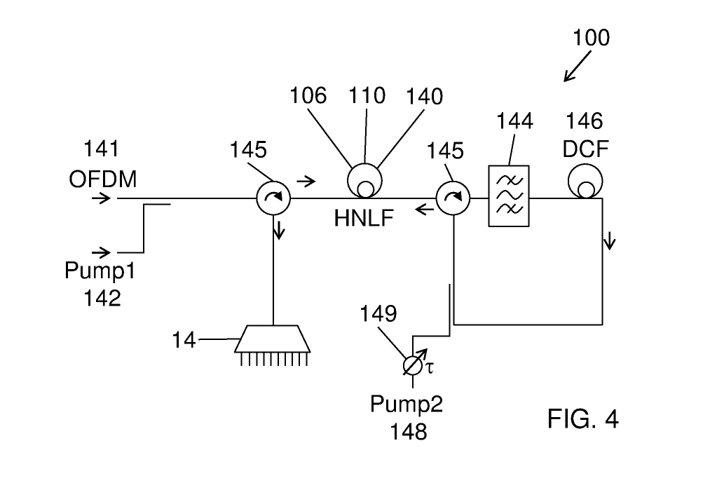

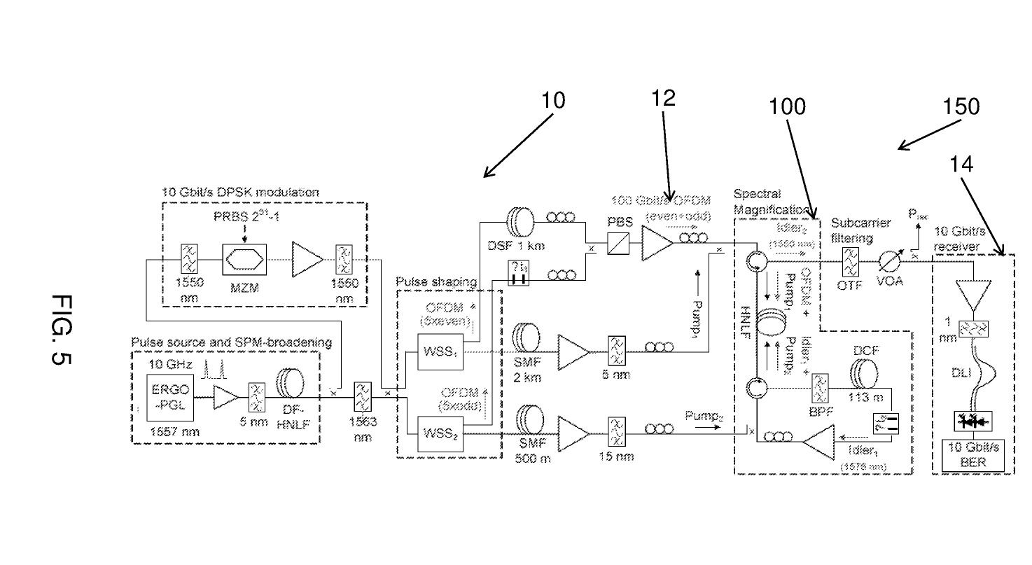

FIG. 4 shows an embodiment of the demultiplexer 100, wherein the first time lens 106 and the second time lens 110 share a common nonlinear element 140. The common nonlinear element 140 is here illustrated as a highly nonlinear fibre (HNLF), but may also be implemented e.g. as a silicon nanowire. By chirping and spectrally shaping a first optical pump signal 142 and injecting it into the common nonlinear element 140 in a first direction, the OFDM signal 141 co-propagating in the first direction will see a first phase modulation, which corresponds to the first time lens 106. After passing the first time lens, the signal is bandpass filtered 144 to remove any residual part of the first optical pump signal 142, before the signal is dispersed in the dispersive element 146. Here, the dispersive element 146 is illustrated as a dispersion compensating fibre (DCF), but the skilled person will readily identify other suitable dispersive elements. A second optical pump signal 148 is then mixed with the data signal, after having passed an adjustable delay element 149 functioning to temporally align pulses of the second optical pump signal 148 to the bit slots of the OFDM signal. The mixed signal is made to do a second pass of the common nonlinear element 140, thus generating a second phase modulation, corresponding to the second time lens 110. At this point, the OFDM signal has been spectrally magnified, so as to allow extraction of the individual subcarriers by e.g. simple bandpass filtering, such as detection with a WDM receiver. To direct the propagation of light through the device, two circulators 145 are inserted in the optical path.

### Example 1

FIGS. 5-8 illustrates a proof-of-principle experiment testing aspects of the invention. To verify the principle, spectral magnification ×4 was performed on an emulated 100 Gbit/s OFDM super-channel consisting of ten 10 Gbit/s DPSK (differential phase-shift keying) subcarriers with 12.5 GHz spacing. The parabolic phase-modulation for the time-lenses was in this embodiment achieved by FWM between the OFDM signal and linearly chirped pump pulses.

The experimental set-up 150 is shown in FIG. 5, in which the transmitter system 10, the incoming OFDM signal 12, the demultiplexer 100, and the receiver 14 are indicated. The output of a 10 GHz Erbium-glass oscillator pulse generating laser source (ERGO-PGL) at 1557 nm was spectrally broadened by self-phase modulation in a dispersion-flattened highly nonlinear fibre (DF-HNLF). A supercontinuum (SC) thus generated was filtered at 1550 nm using a 5 nm optical band-pass filter (BPF), and the resulting signal was encoded by differential phase-shift keying with a 2³¹−1 pseudo-random bits pattern(PRBS). The resulting white spectrum was then sinc-filtered to obtain OFDM subcarriers. To obtain a signal for pump generation, the SC was bandpass-filtered (BPF) around 1563 nm. Both aforementioned signals were recombined and sent to two wavelength selective switches WSS1 and WSS2 (Finisar Waveshaper 4000S) for pulse shaping. The OFDM signal was emulated by separately generating even and odd subcarriers, each consisting of five 12.5 GHz sinc functions with 25 GHz spacing. The sign was reversed between neighbouring sinc subcarriers (for both even and odd), in order to overcome a limited WSS resolution of ˜10 GHz and thus obtaining the highest possible contrast ratio in the generated sinc spectra. The even OFDM subcarriers and the pump signal for the first time-lens (pump1) were generated in WSS1, and the odd OFDM subcarriers and the pump signal for the second time-lens (pump2) were generated in WSS2. Pump1 and pump2 are chirped using 2 km and 0.5 km SMF (standard single-mode fibre), respectively, resulting in a ×4 spectral magnification. The even and odd subcarriers were de-correlated using a 1 km dispersion shifted fibre (DSF), bit-wise synchronised and recombined in the same polarisation using a polarising beam splitter (PBS). The FWM processes for this embodiment of the two time lenses were achieved in a single HNLF using a counter-propagation scheme, where in- and outgoing signals were separated using circulators. The HNLF has a length of 500 m, a zero dispersion wavelength of 1561 nm, a dispersion slope of 0.017 ps/nm² km, and a non-linear coefficient of ˜10 W⁻¹ km⁻¹.

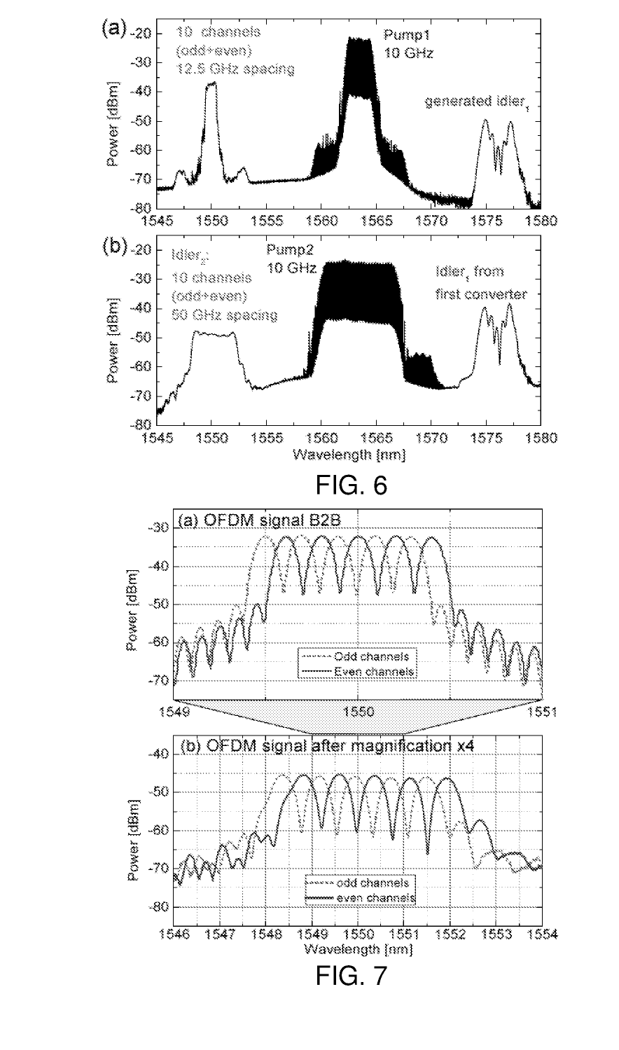

The HNLF output spectrum, corresponding to an intermediate signal after the first time lens, resulting from the FWM between pump1 and the OFDM signal is shown in FIG. 6 (a). An idler signal at 1576 nm was filtered out using a BPF, and propagated through a 113 m dispersion-compensating fibre (DCF). The signal was then combined with pump2 and coupled into the HNLF for the second FWM process. The resulting spectrum after the second time lens is shown in FIG. 6 (b). The generated idler in the second time lens corresponds to the output OFDM spectrum, magnified by a factor 4 compared to the input.

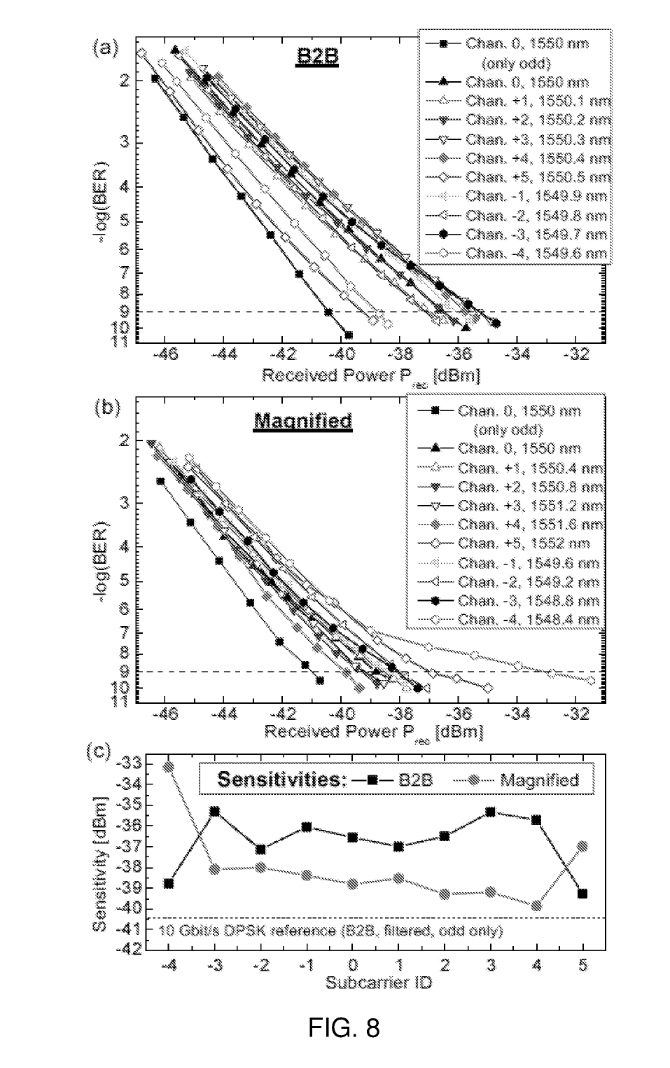

FIGS. 7 (a) and (b) show the original and magnified OFDM spectrum for the even and odd subcarriers, respectively, revealing a good resemblance. The subcarriers were individually filtered out using an optical tunable filter (Santec OTF-350), with a Gaussian profile of 0.12 nm full-width at half maximum (FWHM). The bit-error rate (BER) performance was measured in a 10 Gbit/s pre-amplified DPSK receiver with a 10 GHz delay interferometer (DLI) and balanced photo-detection. For reference, the subcarriers of the original OFDM signal are filtered out using the OTF tuned to 0.08 nm FWHM back-to-back (B2B). The resulting 10 Gbit/s DPSK BER curves were plotted in FIG. 8 (a,b), and the corresponding sensitivities (Pres at BER=10⁻⁹) are plotted in FIG. 8 (c). Note that the error-free performance even in the B2B case originates in the sign reversal between the even/odd neighbour subcarriers, which underestimates the cross-talk compared to a true OFDM signal with fully decorrelated subcarriers. However, even for this situation, the spectral magnification leads to an improvement in sensitivity from 0.9 to 4.1 dB for all subcarriers except for the two outermost subcarriers (ID −4 and +5). The penalties for ID −4 and +5 are attributed to increased ICI from the neighbour subcarriers, due to some spectral distortion introduced by the time-lenses as can be observed in FIG. 7 (b). The inventors foresee improved performance with better optimized pump signals and larger FWM bandwidth.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method of all-optical demultiplexing of an optical orthogonal frequency division multiplexing (OFDM) signal, the method comprising:
providing an input OFDM signal comprising a plurality of subcarriers, the subcarriers corresponding to data channels,
ensuring that bit sequences of the individual data channels are substantially synchronized within the input OFDM signal, and
all-optical spectrally magnifying the input OFDM signal by use of an optical time lens and a dispersive element.

2-15. (canceled)

16. The method according to claim 1, wherein spectrally magnifying the input OFDM signal comprises:
applying a first phase modulation to the input OFDM signal in a first time lens to obtain a first chirped signal, the first phase modulation being substantially quadratic as a function of time substantially throughout a bit time slot of a subcarrier and having a chirp rate C₁,
applying chromatic dispersion via the dispersive element to the first chirped signal to obtain a dispersed signal, the chromatic dispersion having a dispersion parameter D, and
applying a second phase modulation to the dispersed signal in a second time lens to obtain a spectrally magnified signal, the second phase modulation being substantially quadratic as a function of time substantially throughout the bit time slot and having a chirp rate C₂, wherein the chirp rates and dispersion parameter are chosen to fulfill:
$$D = \frac{1}{{C}_{1}} + \frac{1}{{C}_{2}} ,$$
and wherein the spectral magnification is given by
$$M = - \frac{{C}_{2}}{{C}_{1}} .$$

17. The method according to claim 16, wherein the chirp rates are selected to give a spectral magnification in the range 2-100, 2.5-10, or 3-8.

18. The method according to claim 1, further comprising detecting a data content of a subcarrier with a receiver.

19. An all-optical demultiplexer for an optical orthogonal frequency division multiplexing (OFDM) signal having a centre wavelength, the OFDM signal comprising a plurality of subcarriers, each subcarrier having a symbol rate, the demultiplexer configured for spectral magnification of the OFDM signal and comprising:
a first time lens, being operable to have a substantially quadratic phase modulation as a function of time over a time period substantially corresponding to the symbol rate, the phase modulation having a chirp rate C₁,
a second time lens, being operable to have a substantially quadratic phase modulation as a function of time over a time period substantially corresponding to the symbol rate, the phase modulation having a chirp rate C₂, and
a dispersive element, the dispersive element being arranged in a signal path between the first time lens and the second time lens, the dispersive element having a dispersion parameter D, at the centre wavelength, wherein
the chirp rates C₁, C₂ and the dispersion parameter D may be chosen to substantially fulfil
$$D = \frac{1}{{C}_{1}} + \frac{1}{{C}_{2}} .$$

20. The demultiplexer according to claim 19, wherein the demultiplexer further comprises a synchronizer for aligning bit slots of the individual subcarriers to substantially coincide.

21. The demultiplexer according to claim 20, wherein the synchronizer is or comprises a chromatic dispersion compensator, or a dispersion compensating fibre (DCF).

22. The demultiplexer according to claim 19, wherein the first time lens and the second time lens comprise a common nonlinear element, wherein the common nonlinear element is configured to function as the first time lens for a first signal propagating along a first propagation direction and is adapted to function as the second time lens for a second signal propagating along a second propagation direction.

23. The demultiplexer according to claim 19, wherein the first and/or second time lens is configured for phase modulation by a χ⁽³⁾-effect.

24. The demultiplexer according to claim 19, wherein the demultiplexer comprises an optical pump for generating chirped pump pulses, and wherein the first and/or second time lens is configured for phase modulation by four-wave mixing (FWM) between the chirped pump pulses and the signal.

25. The demultiplexer according to claim 19, wherein the demultiplexer comprises an optical pump for generating parabolic intensity profile pump pulses, and wherein the first and/or second time lens is configured for phase modulation by cross-phase modulation (XPM) between the parabolic intensity profile pump pulses and the signal.

26. The demultiplexer according to claim 19, wherein the first and/or second time lens is configured for phase modulation by a χ⁽²⁾-effect.

27. The demultiplexer according to claim 19, wherein the first and/or second time lens is or comprises an electro-optic phase modulator.

28. The demultiplexer according to claim 19, wherein the dispersive element is or comprises an optical fibre.

29. The demultiplexer according to claim 19, wherein said demultiplexer is configured to perform the method according to claim 1.
